(19) United States
(12) Patent Application Publication
(10) Pub. No.: US 2022/0244975 A1
(43) Pub. Date: Aug. 4, 2022

(54) METHOD AND SYSTEM FOR GENERATING NATURAL LANGUAGE CONTENT FROM RECORDINGS OF ACTIONS PERFORMED TO EXECUTE WORKFLOWS IN AN APPLICATION

(71) Applicant: INTUIT INC., Mountain View, CA (US)

(72) Inventors: Colton Arthur Gordon BEGERT, Edmonton (CA); Richard Jan DE DEASIS, Edmonton (CA); Mawuse GOLOKUMA, Edmonton (CA); Parisa MOHEBBI, Toronto (CA)

(21) Appl. No.: 17/163,167

(22) Filed: Jan. 29, 2021

(51) Int. Cl. G06F 9/451; G06F 8/73; G06F 11/36

(52) U.S. Cl. CPC G06F 9/453; G06F 11/3664; G06F 8/73

(57) ABSTRACT

Certain embodiments of the present disclosure provide techniques for generating natural language content describing a workflow in an application from recordings of actions performed to execute the workflow. An example method generally includes generating a description of actions performed to complete the workflow in a first version of the application. The workflow in a second version of the application is executed based on the generated description of actions. An updated description of actions performed to complete the workflow is generated based on executing the workflow in the second version of the application. Natural language content describing the workflow is generated, using a natural language generation engine, based on the updated description of actions performed to complete the workflow. The natural language content describing the workflow is output to a user-accessible content repository associated with the application.

### INTRODUCTION

Embodiments of the present disclosure relate to generating natural language content describing workflows in a software application, and more specifically to continually generating natural language content from recordings of actions performed to execute workflows in a software application.

### BACKGROUND

Applications may implement various workflows that a user can execute in order to perform various actions in the applications. For example, workflows in an application may include a user login or registration workflow, various user account information editing workflows, and various workflows for performing functions exposed by the application. In a tax preparation application, these workflows may include, for example, workflows for entering information from various forms, calculating a tax liability based on the data entered from these forms, or the like. In another example, for an accounting application, these workflows may include workflows for generating invoices, recording payments, recording expenses, or the like.

To aid users in using these applications, help content may be written to describe, in natural language, the steps that users are to perform in order to execute workflows in these applications. Because these applications may include a large number of workflows, a large number of natural language descriptions (e.g., in different files) may be written to describe how to execute the workflows in the application. Manually generating these natural language descriptions may be a time-consuming process. The number of natural language descriptions may also increase as different variations of a workflow are implemented in an application, as an application expands to include support for different languages, or the like. Further, updates to an application may entail changes to a workflow, which may trigger further manual updates to the natural language description(s) of these workflows.

Accordingly, techniques are needed for automatically generating natural language descriptions of workflows in a software application.

### BRIEF SUMMARY

Certain embodiments provide a computer-implemented method for generating natural language content describing a workflow in an application. The method generally includes generating a description of actions performed to complete the workflow in a first version of the application. The workflow in a second version of the application is executed based on the generated description of actions. An updated description of actions performed to complete the workflow is generated based on executing the workflow in the second version of the application. Natural language content describing the workflow is generated, using a natural language generation engine, based on the updated description of actions performed to complete the workflow. The natural language content describing the workflow is output to a user-accessible content repository associated with the application.

Other embodiments provide a computer-implemented method for generating natural language content describing each of a plurality of variations of a workflow in an application. The method generally includes generating natural language content describing a workflow in an application. The method generally includes generating a description of actions performed to complete a first variation of the workflow in a first version of the application. A plurality of variations of the workflow in a second version of the application are executed based on the generated description of actions performed to complete the first variation of the workflow. For each respective variation in the plurality of variations of the workflow, a variation-specific description of actions performed to complete the respective variation of the workflow is generated. For each respective variation of in the plurality of variations of the workflow, natural language content describing the respective variation of the workflow is generated, using a natural language generation engine, based on the updated description of actions performed to complete the respective variation of the workflow. The natural language content describing each respective variation of the plurality of variations of the workflow is output to a user-accessible content repository associated with the application.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain embodiments of the one or more embodiments and are therefore not to be considered limiting of the scope of this disclosure.

FIG. 1 depicts an example computing environment in which natural language content describing workflows in a software application are generated based on recordings of actions performed complete a workflow in the software application.

FIG. 2 illustrates an example of a workflow, structured files describing actions performed in completing the workflow, and natural language content describing the workflow generated based on the structured files.

FIG. 3 illustrates example operations for generating natural language content describing workflows in a software application based on recordings of actions performed to complete a workflow in the software application.

FIG. 4 illustrates example operations for generating natural language content describing a workflow in a software application based on a filtered recording of actions performed to complete the workflow.

FIG. 5 illustrates example operations for generating natural language content describing variations of a workflow in a software application based on recordings of actions performed to complete a base variation of the workflow in the software application.

FIG. 6 illustrates an example computing system on which embodiments of the present disclosure may be implemented.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Embodiments of the present disclosure provide apparatuses, methods, processing systems, and computer-readable mediums for generating natural language content describing actions performed to execute a workflow in a software application based on recordings of actions performed to execute the workflow. Generally, the natural language content may be periodically verified and updated to ensure that the natural language content accurately describes the workflow. As workflows are updated, causing changes to how users interact with the application to execute the workflow, previous recordings of actions performed to execute the workflow in previous versions of the application may fail. Meanwhile, workflows that have not significantly changed from previous versions of an application may continue to work when executed based on a previous recording of actions performed to execute the workflow in previous versions of the application.

As discussed, applications may implement a plurality of workflows. These workflows may be independently updated over time, which may necessitate changes to self-help or other natural language content describing the workflow. Because an application may include a large number of workflows, manual generation of natural language content describing workflows in the application may not be an easily scalable process. For example, updates to the natural language content describing workflows in the application may be triggered by user identification of natural language content that does not match the version of the workflow that is currently implemented in the application. In response, a ticket may be manually generated to initiate an update to the natural language content describing the workflow. The update to the natural language content may be eventually generated; however, because this may be a time-consuming process, a significant amount of time may elapse between identification of a divergence between the natural language content describing the workflow and the actual implementation of the workflow.

Still further, scalability problems in generating natural language content describing a workflow may be exacerbated by support for different variations of a same workflow. For example, different variations of a workflow may be implemented for to support use and deployment of an application in different geographical regions. In such a case, natural language content describing the workflow may be written in a plurality of different languages. When the implementation of a workflow diverges from the natural language description(s) of the workflow, multiple natural language descriptions may need to be updated. However, because divergences between the natural language descriptions of the workflow and the implementation of each variation of the workflow may be individually flagged, the natural language descriptions of the workflow may be updated in piecemeal.

Embodiments described herein provide techniques for continually updating natural language descriptions of workflows in an application. By using previously generated recordings of actions performed to validate whether natural language content describing a workflow is still accurate, embodiments described herein may efficiently identify workflows in an application for which automatic updates to the natural language content describing the identified workflows may not be successful. The natural language content describing the identified workflows may thus be flagged for manual generation and updating without needing manual identification by users of the software application. Meanwhile, the natural language content describing other workflows that have not significantly changed may be updated to reflect the most recent implementation of the workflow in the software application. Thus, the natural language content describing workflows in an application may be continuously updated. These continuous updates to the natural language content may ensure that, in a continuous integration/continuous development pipeline, applications may be continually developed without significant divergences developing between the implementation of workflows in the application and the natural language content describing these workflows.

### Example Systems for Generating Natural Language Content Describing Workflows in an Application from Recordings of Actions Performed to Execute Workflows in an Application

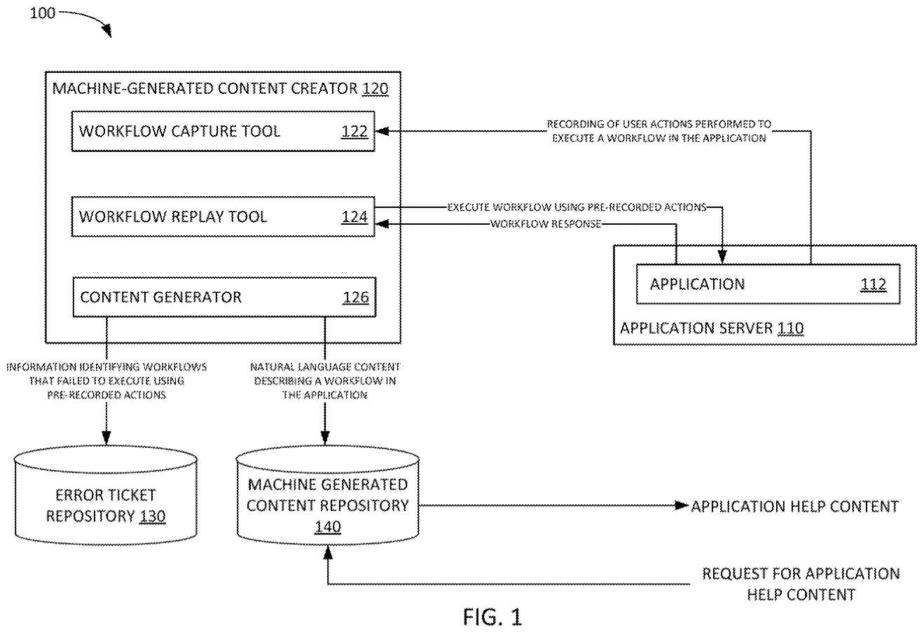

FIG. 1 illustrates an example computing environment 100 in which recordings of actions performed to execute workflows in an application are used to generate natural language content and to identify workflows for which natural language content may not be automatically generated based on prior recordings of the actions performed to execute the identified workflows in previous versions of the application.

As illustrated, computing environment 100 includes an application server 110, a machine-generated content creator 120, an error ticket repository 130, and a machine-generated content repository 140. Computing environment 100 may be an environment through which recordings of actions performed to execute a workflow in an application can be generated and replayed to generate natural language content describing workflows in the application and to identify workflows in the application for which natural language content may not be automatically generated. It should be recognized that generation of natural language content describing workflows in an application may be performed on a single physical computing device (e.g., a server), a cluster of computing devices, a virtualized environment in which services hosted by virtual machines executing on one or a cluster of computing devices, or any other computing environment in which requests to execute or perform functions may be received from external software applications or services.

Application server 110 generally is representative of one or more computing systems on which an application 112 may be deployed. Application server 110 may be, for example, a single server, a cluster of servers, one or more virtual machines, or the like. The virtual machines on which application 112 may be deployed may be persistent virtual machines and/or dynamically generated virtual machines that may be instantiated to support dynamic processing loads generated by users of the application 112.

Application 112 may be managed and deployed through a continuous integration/continuous deployment pipeline in which updates to application components (e.g., components of application 112 implementing different workflows in the application 112) are deployed as such updates become available. Thus, in a continuous integration/continuous deployment pipeline, some workflows may operate similarly at a first time and a second time, while other workflows may operate in a first manner at a first time and a significantly different manner at a second time.

Application 112 may additionally provide a support request system that allows users of the application 112 to request help in using the application. The support request system may, in some embodiments, allow a user of the application 112 to retrieve natural language content describing workflows implemented in the application 112 from machine generated content repository 140. The support request system may also allow users to request support through other, more interactive, mechanisms, such as through a support chatbot or through a live support system allowing the user to interact with a support agent in real time (e.g., through a text chat mechanism, voice communication session, etc.).

Machine generated content creator 120 generally exposes mechanisms that allow for the recording of actions performed to execute workflows in application 112, the generation of natural language content describing workflows in application 112, and the identification of workflows for which natural language content cannot be automatically generated. As illustrated, machine generated content creator 120 includes a workflow capture tool 122, workflow replay tool 124, and content generator 126.

Workflow capture tool 122 generally allows a user of machine generated content creator 120 to execute workflows in application 112 and record the actions performed to execute these workflows in application 112. To record the actions performed to execute a workflow in an application 112, workflow capture tool 122 can implement a web browser session and capture each action performed during the web browser session. These actions may include actions executed by the web browser, such as setting environment variables, enabling or disabling cookies, or the like, as well as user-performed actions, such as selecting and/or otherwise interacting with user interface elements included in workflows in the application 112.

To identify user interface elements with which a user interacts during the web browser session in which the user executes the workflow, workflow capture tool 122 can use a cascading style sheet (CSS) selector or other domain object model (DOM) introspection tools to search for information about these user interface elements. In the application, each user interface element may be identified by a combination of a user interface element type (e.g., text boxes, check boxes, option buttons, drop-down menus, etc.) and a name of the user interface element. When a user interacts with a specific element, the workflow capture tool 122 can capture the mechanism by which the user interacted with the user interface element (e.g., a click, typing content into an editable user interface element, etc.), identify the user interface element using the CSS selector or other DOM introspection tools, and generate a record of the interaction. In some cases, where a user interface element does not include an automation identifier attribute, other identifying attributes, such as an)(Path attribute in an eXtensible Markup Language (XML) description of the user interface elements in a workflow, may be used to identify the user interface element in a structured file describing the actions performed to execute the workflow, as discussed in further detail below.

Generally, workflow capture tool 122 may generate a structured file including information about each action performed to execute a workflow in the application 112. The structured file may be, for example, an XML file, a JavaScript Object Notation (JSON) file, or other parseable file in which the actions performed to execute the workflow can be stored in the order in which these actions are performed. The file may include, for each recorded action, information identifying the location in the application 112 in which the action was performed (e.g., the name or other unique identifier of a web page in a web-based application, a unique identifier of a form in a non-web-based application, etc.), information identifying the user interface element with which the user interacted, and a type of the interaction. In some embodiments workflow capture tool 122 may sort the entries in the structured file such that actions performed against a user interface element are grouped together, to remove records of extraneous operations (e.g., selection of a user-editable user interface element without a corresponding edit to the selected user interface element), and the like. Generally, by sorting the entries in the structured file and removing records of extraneous operations from the structured file, the structured file may represent the minimum set of actions performed to execute the workflow.

In some embodiments, to preserve privacy, and because the exact content of information provided into the workflow may not be relevant for describing how the workflow is executed, the structured file generated by workflow capture tool 122 may not include the exact content the user input into the user interface elements while executing the workflow. For some workflows, where valid data is to be used in testing the application 112, the structured file may include valid data points that can be used to validate the operations of workflows in the application 112. For example, workflow capture tool 122 can record the username and password associated with a test account so that the same account can be used by workflow replay tool 124 to test a workflow in application 112, as discussed in further detail below.

Workflow replay tool 124 generally uses the structured file generated by workflow capture tool 122 to test the execution of workflows in application 112. To test the execution of a workflow in application 112, workflow replay tool 124 can parse the structured file to identify actions to perform to execute the workflow. For each action, workflow replay tool 124 can programmatically execute the action in a session with application 112. In programmatically executing an action in a session with application 112, for example, workflow replay tool 124 can use one or more testing tools to inject commands into a web browser in which the application 112 executes in order to interact with user interface elements implemented in the workflow.

In some embodiments, workflow replay tool 124 may use a defined data set to test workflows in application 112. In such a case, the defined data set may include information identifying data to be entered into different user interface elements in the workflow for testing. For example, to test a login workflow, the defined data set may include information identifying user credentials for a test user account that the workflow replay tool 124 can inject into the application to test the login workflow. In another aspect, the data injected by the workflow replay tool 124 may be included in the structured file generated by workflow capture tool 122 that describes the actions performed to execute the workflow in the application 112.

In replaying execution of workflows in the application 112, workflow replay tool 124 can also generate a structured file describing the actions performed to execute the workflow. The structured file may be, for example, an XML file, a JSON file, or other parseable file in which the actions performed to execute the workflow can be stored in the order in which these actions are performed. As with the structured file generated by workflow capture tool 122, each entry in the structured file generated by workflow replay tool 124 can include information identifying the location within the application in which an action is performed, the user interface element in the application against which the action is performed, and information about the action performed. The information identifying the location within the application may be, for example, the name of a web page or other web resource in which the action was performed, a unique identifier within the application identifying a step in the application in which an action was performed, or the like. The information identifying the user interface element may be obtained, for example, using a CSS selector, by introspection into the document object model defining the application, using an)(Path identification of an element in an XML definition of a workflow, or identifying some other unique data associated with the user interface element.

In some embodiments, workflow replay tool 124 may additionally generate a video recording of the steps performed to execute the workflow based on the previously generated structured file (e.g., through a screen capturing system integrated into or accessible by workflow replay tool 124). If workflow replay tool 124 receives a response from application 112 indicating that the replay of the workflow based on the previously generated structured file failed, workflow replay tool 124 can generate a ticket to trigger a manual analysis of the workflow. The ticket may include, for example, metadata captured from a session with application 112 in which the workflow failed, information about failed assertions or other checks that caused the workflow to fail, and, in some embodiments, the generated video recording of the steps performed to execute the workflow. If execution of the workflow did not fail, the generated video recording may be discarded (e.g., where storage space or bandwidth restrictions restrict storing and/or serving video content) or may be output to content generator 126 for inclusion into a natural language description of the workflow.

In some embodiments, workflow replay tool 124 may allow for the execution of many variations of a workflow using a single recording of actions performed to execute one variation of the workflow. Workflow replay tool 124 may attempt to execute each variation of the workflow by injecting the actions identified in the single recording and generate, for each variation of the workflow, a structured file identifying the actions performed in executing the workflow. The structured file associated with each variation of the workflow may include information identifying the variation of the workflow. As discussed in further detail below, the information identifying the variation of the workflow may be used, for example, to identify a language in which the natural language description of the variation of the workflow is to be written, or other contextual information that may be used to aid in generating the natural language description of the variation of the workflow.

Content generator 126 generally uses the recordings generated by workflow replay tool 124 to generate natural language content describing workflows that workflow replay tool 124 successfully executed. The natural language content generated by content generator 126 may be committed to machine-generated content repository 140, which serves as a repository for help or other descriptive content that users of application 112 can access through the application 112 or outside of the application 112 (e.g., through a web browser).

To generate natural language content describing a workflow, content generator 126 may pre-process (e.g., filter) the structured file generated by workflow replay tool 124 describing the actions performed to execute the workflow. In pre-processing the structured file, content generator 126 can remove records of actions that are not performed by users of the software application, but are performed by a web browser or by the application and are typically invisible to the user of the software application. For example, records associated with browser-specific or testing tool-specific commands, such as setting environment variables, pausing and/or resuming script execution, waiting for user interface elements to become visible, processing of assert statements in testing an application, or the like may be removed from the structured file. Thus, what remains of the structured file may be records identifying the actions performed by a user of the application to execute the workflow.

In many cases, a user may perform multiple actions with respect to a user interface element in order to execute a workflow. For example, to interact with a text box that allows for user input or the editing of existing information, a user may select the text box (e.g., by clicking the text box, tabbing over to the text box, or otherwise causing the text box to be the subject of input focus), and then type content into the text box. Because one action may be understood to be a prerequisite of another action, generating natural language content including information about both actions may result in a natural language description of the workflow that is redundant or repetitive. Thus, content generator 126 can consolidate records of multiple related actions into a single action.

To consolidate records of multiple related actions into a single action, content generator 126 can use one or more defined rules to identify records that are to be consolidated into a single action. These rules may for example, specify that records of actions that are to be preserved include records identifying a change to a state of a user interface element or the data displayed in the user interface element. Using the text box editing example again, selection of a text box does not change the state of the user interface element or the data displayed in the user interface element. However, typing information into the text box does change the state of the user interface element or the data displayed in the user interface element. Thus, the rules identifying records to be deleted may specify that the record in the structured file corresponding to selection of a text box user interface element, when accompanied by a record specifying text entry into the text box, may be deleted. In another example, suppose that the structured file generated by workflow replay tool includes a first record identifying a selection of an item in a first user interface element and a second record indicating that the selected item in the first user interface element is dragged to a second user interface element. Because the action that changes the state of or the content included in a user interface element is the action associated with the second record, the rules may specify that the first record is to be deleted.

After the structured file generated by the workflow replay tool 124 is pre-processed (including the filtering techniques discussed above), content generator 126 can generate natural language content from the pre-processed structured file. To generate natural language content describing a workflow, content generator 126 can generate sentences for each record in the pre-processed structured file according to templates associated with each action record in the pre-processed structured file. In some embodiments, content generator 126 may be configured to aggregate information about actions performed in a same location in the application into a single sentence based on the template. For example, suppose that a workflow includes a number of consecutive records indicating that data is entered into text boxes in a particular location in the application. Instead of generating natural language content including discrete sentences for each record, content generator 126 can consolidate these records into a single record identifying a series of data entry steps performed in that location in the application, as discussed in further detail below.

In some embodiments, content generator 126 can perform cycle detection against the records included in the pre-processed structured file to identify locations at which paragraph breaks are to be inserted in the natural language description of a workflow. Generally, to identify cycles in the records included in the pre-processed structured file, content generator 126 can examine the location associated with each record in the structured file to identify changes in the locations at which actions are performed. Because changes in the locations at which different actions are performed generally indicate the performance of different discrete steps in the workflow, identifying such changes (and the corresponding execution cycles in the recorded actions included in the pre-processed structured file) may indicate locations at which a natural break in text content may be located.

For example, suppose that content generator 126 is generating a natural language description of a workflow for generating an invoice in an accounting application for a new client. The recorded actions may thus include a first set of actions for adding a new client to a database, a return to a landing page, and a second set of actions for generating an invoice for the client. The return to the landing page may indicate that the first set of actions is naturally described in a first paragraph, and the transition from the landing page may indicate that the second set of actions is naturally described in a second paragraph.

After identifying locations at which line breaks may be inserted into a natural language description of actions performed to execute a workflow, content generator 126 can generate the natural language description by mapping records to corresponding natural language templates. In some embodiments, the natural language templates may include a plurality of templates that correspond to different types of actions. One template may be used to generate natural language content from action records that identify a single location in the application, a single action, and a single target user interface element. Another template may be used to generate natural language content from action records that identify a single location in the application, a single action, and a plurality of target user interface elements. Still further templates may be used to generate natural language content from action records that identify an action and a target user interface element, but do not include location information in the record. It should be recognized, however, that any number of templates may exist and may be used to generate natural language content for any combination of application location information, action information, and target user interface element information.

Content generator 126, as discussed, may commit the generated natural language descriptions of actions performed to execute a workflow to machine generated content repository 140 for future accessibility. Generated natural language descriptions may periodically overwrite content for the same workflow associated with previous versions of a workflow so that the content remains up to date and synchronized with the workflows implemented in application 112. Machine-generated content repository 140 may be a searchable repository accessible from within application 112 or from applications other than application 112 and may allow users to search for and retrieve content describing the actions performed to execute any workflow implemented in application 112.

Generally, workflow replay tool 124 and content generator 126 may execute periodically in order to ensure that the natural language descriptions of workflows in application 112 are updated and accurately reflect the operations of the workflows in application 112.

For example, workflow replay tool 124 and content generator 126 may be scheduled by a daemon or other service executing on machine-generated content creator 120 to test the execution of workflows in application 112 and either generate content or flag workflows for manual investigation at a set time every day or according to some other defined periodicity.

The schedule on which workflow replay tool 124 and content generator 126 execute may be established to minimize performance impacts on application 112 to other users of the application. For example, workflow replay tool 124 and content generator 126 may be scheduled to execute when few users are expected to use the application 112. In some embodiments, the scheduling may allow for execution of variations of a workflow independently so that users in different regions associated with the different variations of the workflow do not experience performance degradation due to automated execution of the workflows at times of peak demand.

### Example Natural Language Content Describing a Workflow Generated from Recorded Actions Performed to Execute the Workflow

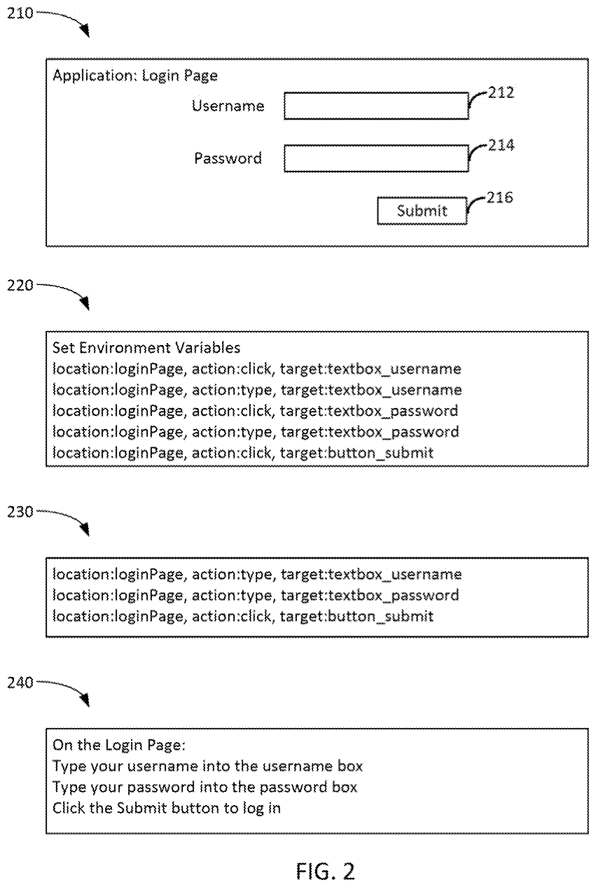

FIG. 2 illustrates an example of a workflow, structured files describing actions performed in completing the workflow, and natural language content describing the workflow generated based on the structured files.

As illustrated, workflow 210 implements a login workflow in an application, such as application 112 illustrated in FIG. 1. In the login workflow, a user provides username and password credentials into user interface elements of an application to authenticate and commence execution of the features exposed by the application. In particular, workflow 210 includes a username text box 212, password text box 214, and a submit button 216.

To generate content describing the workflow 210, a recording 220 of actions performed to complete the workflow 210 in an application may be generated. Recording 220 may be generated, for example, by workflow replay tool 124 illustrated in FIG. 1 or other capture tools executing on one or more computing systems that execute actions in an application based on previously generated recordings. As illustrated, recording 220 includes a plurality of records. Some of these records (e.g., the record with the description “Set Environment Variables”) represent actions performed by a web browser or test tool, and other records represent actions that are performed by a user of the application.

Prior to generating the natural language content 240 describing the workflow 210, recording 220 may be pre-processed to generate a filtered version 230 of the recording 220. As discussed, the reduced version 230 of the recording 220 may be generated to consolidate redundant records into a single record describing an action performed against a user interface element. In this example, a record including “action:click” for each of the username text box 212 and the password text box 214 are succeeded by a record including “action:type” for each text box. Because the “action:click” records do not change the state of the text boxes or the data included in these text boxes, and because the “action:type” records to change the state of the text boxes or the data included in these text boxes, a content generator (e.g., content generator 126 illustrated in FIG. 1) can consolidate these click/type record pairs into a single record. In some aspects, to pre-process the recording 220, the content generator can delete the click record in click/type record pairs, resulting in a recording that only includes the “action:type” records for these pairs of records.

Natural language content 240 is illustrative of natural language content describing workflow 210 that may be generated by applying natural language templates to each record included in the reduced version 230 of the recording 220. In this example, the templates for each “type” record may be associated with the “type” action and may specify the data to enter and the target user interface element. The sentence generated for the “click” record may be associated with the “click” action and may specify the user interface element to be clicked in order to complete the workflow.

### Example Generation of Natural Language Content Describing Workflows in an Application From Recordings of Actions Performed to Execute Workflows in an Application

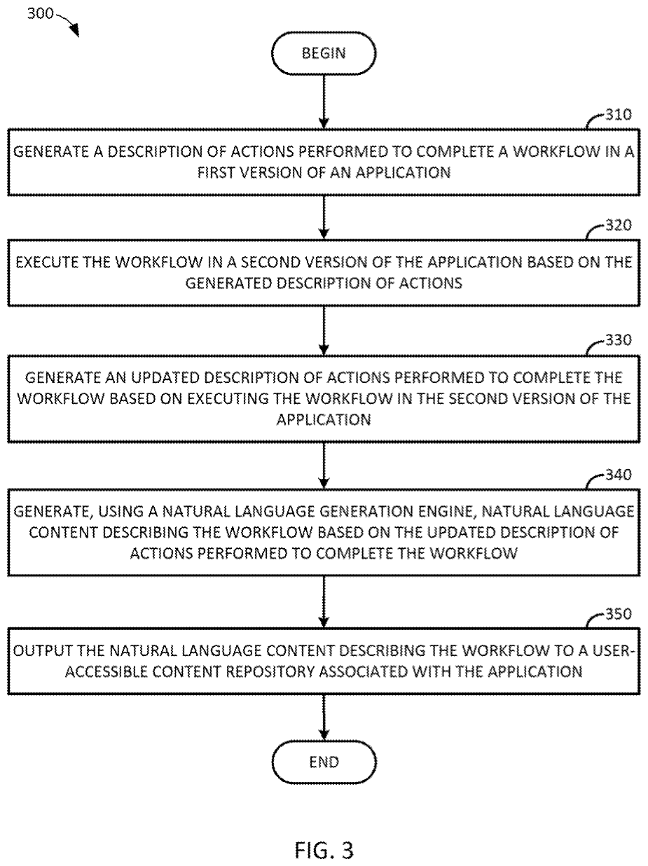

FIG. 3 illustrates example operations 300 for generating natural language content describing workflows in an application from recordings of actions performed to execute these workflows. The operations described herein may be executed by one or more systems in a computing environment (e.g., a machine generated content creator 120 illustrated in FIG. 1).

As illustrated, operations 300 begin at block 310, where a system generates a description of actions performed to complete a workflow in a first version of an application. The description of the actions performed to complete the workflow in the first version if the applications may be generated, in some embodiments, by recording user interactions with user interface elements presented in the workflow. The generated description may, in some embodiments, be a structured file generated from the recorded user interactions and may include a plurality of records, each record being associated with a particular user interaction with a target user interface element in the application. In some embodiments, the structured file may be ordered based on a chronological order in which each user interaction was performed.

In some embodiments, the structured file may be an XML file, a JSON representation, or other parseable file in which records of user interaction with user interface elements are stored for future use in testing a workflow. Each entry in the structured file may represent a record of an interaction with a single targeted user interface element of the user interface elements presented in the workflow. Each entry may include an identification of the targeted user interface element and an action performed with respect to the single user interface element (e.g., click, type, selection of a particular item in a list of items, etc.).

At block 320, the system executes the workflow in a second version of the application based on the generated description of actions. To execute the workflow in the second version of the application, the system, can generate, for each entry in the generated description of actions, a command for a web browser to perform a specified action against a specified user interface element in the workflow. Each command may be executed in the web browser. Generally, to execute a command in the web browser, the command may be input into a testing framework that programmatically injects commands into an instance of the web browser to simulate user input into or user interaction with user interface elements displayed in the web browser. The testing framework may, for example, be a tool used by workflow replay tool 124 illustrated in FIG. 1 to allow for automated, programmatic testing of software applications, such as application 112 illustrated in FIG. 1.

At block 330, the system generates an updated description of actions performed to complete the workflow based on executing the workflow in the second version of the application. To generate the updated description of actions, the system can capture the actions injected into the web browser and generate a plurality of records for the updated description. Each record may include, for example, an identification of a location in an application in which an action is performed, the target user interface element against with the action is performed, and the type of action performed, to name a few examples.

In some embodiments, the system can additionally generate a video recording of executing the workflow in the second version of the application. The video recording may be retained until the system determines that the workflow executed successfully. If the system determines that the workflow failed to execute successfully, the system can generate an entry in an error ticket repository identifying the workflow as a workflow for which manual attention is needed. In some embodiments, the entry can also include the generated video recording, which may aid in identifying reasons why the workflow failed to execute successfully.

At block 340, the system generates, using a natural language generation engine, natural language content describing the workflow. The natural language content describing the workflow may be generated based on the updated description of actions performed to complete the workflow. Generally, as discussed above, the system can generate the natural language content based on a filtered version of the updated description of actions performed to complete the workflow to remove records of actions performed by a web browser or testing framework used in generating the updated description of actions. The system may also consolidate records of successive actions performed against the same user interface element into a single record, which may aid in generating natural language content that does not include redundant information.

In some embodiments, to generate natural language content, the system can identify a natural language template to use for each record in the updated description of actions performed to complete the workflow. The natural language template may correspond to a specified action and targeted user interface element(s), and a natural language representation of each record in the updated description of actions may be generated based on the identified natural language template, the target user interface element included in the entry, and action performed against the target user interface element included in the entry.

In some embodiments, to generate natural language content, the system can identify, in the updated description of actions performed to complete the workflow, a transaction from a first location in the application to a second location in the application. In the natural language content, the system inserts a paragraph break between a description of actions performed in the first location in the application and a description of actions performed in the second location in the application.

At block 350, the system outputs the natural language content describing the workflow to a user-accessible content repository associated with the application. Generally, natural language content may be persisted to the user-accessible content repository for workflows in the second version of the application that were successfully executed based on the generated description of actions performed to complete the workflow in the first version of the application.

In some embodiments, the system can generate the description of actions performed to complete the workflow in the first version of the application based on a recording of actions performed to execute a base variation of the workflow in the first version of the application. The system can then execute the workflow in the second version of the application by executing a plurality of variations of the workflow based on the recording of the actions performed to execute the base variation of the workflow in the first version of the application. In some embodiments, generating the natural language content describing the workflow may include, for each respective variation of the plurality of variations of the workflow, generating a natural language description of actions performed to execute the respective variation of the workflow in a language associated with the respective variation of the workflow.

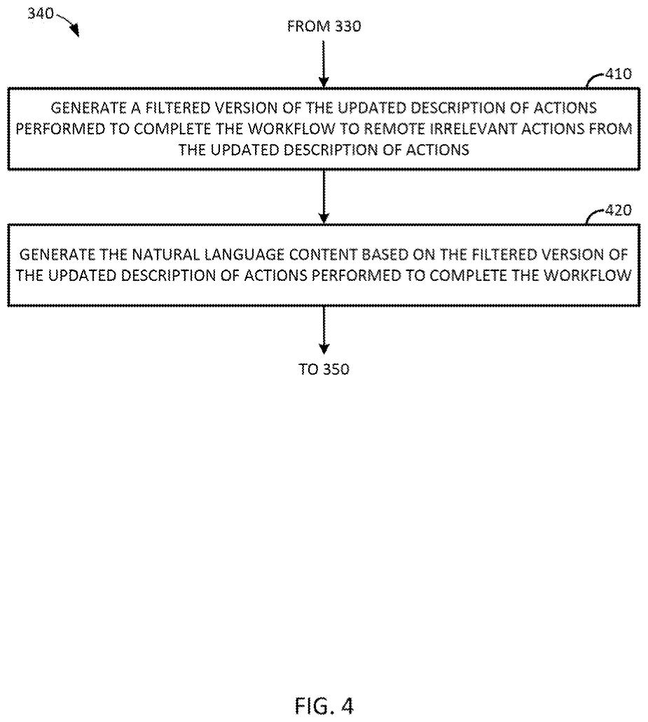

FIG. 4 illustrates further details of block 340 illustrated in FIG. 3 for generating natural language content describing the workflow based on the updated description of actions performed to complete the workflow.

As illustrated, block 340 may begin at block 410, where a system generates a filtered version of the updated description of actions performed to complete the workflow. Generally, in generating the filtered version of the updated description of actions, the system may remove redundant actions from the updated description of actions.

In some embodiments, to generate the filtered version of the updated description of actions, the system can remove actions performed by a test framework to execute the workflow in the second version of the application. These actions may include, for example, setting environment variables for executing the workflow using the test framework, evaluation of assertions used to determine whether conditions allowing execution to continue exist, and other actions recorded in the updated description of actions that are not performed by a user of the application.

In some embodiments, to generate the filtered version of the updated description of actions, the system can consolidate records of successive actions performed against a same target user interface element into a single record. The single record may be, for example, the record associated with an action that changes a state of a user interface element or the data displayed in the user interface element. For example, for a pair of records including a record of a click action and a record of a type action against a user interface element, the record of the click action may be removed from the updated description of actions. Generally, by consolidating records of successive actions performed against a same target user interface element, successive entries in the filtered version of the updated description of actions have different target user interface elements.

At block 420, the system generates the natural language content based on the filtered version of the updated description of actions performed to complete the workflow. After generating the natural language content based on the updated description of actions performed to complete the workflow, the system executes block 350, discussed above.

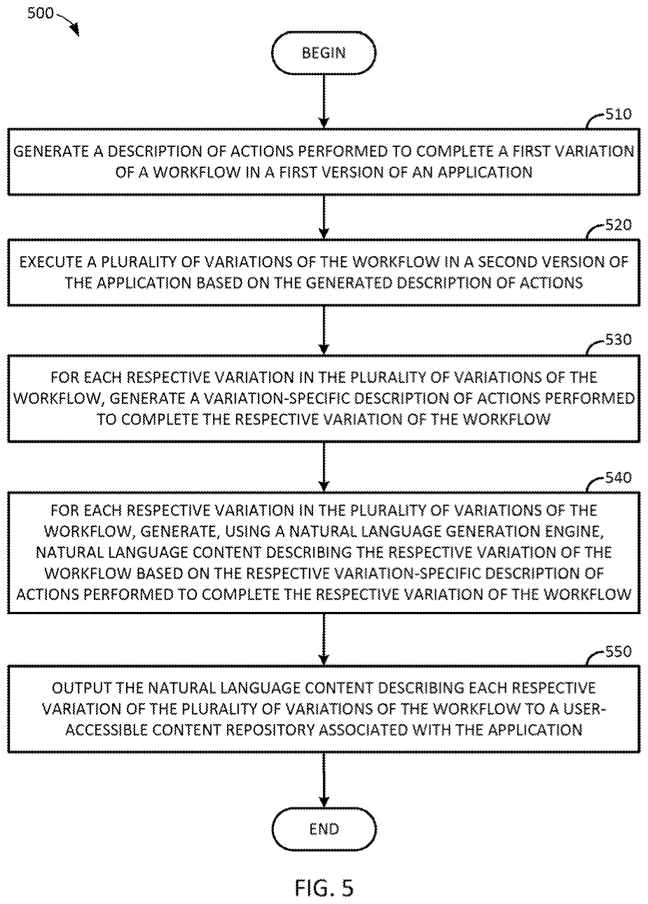

FIG. 5 illustrates example operations 500 that may be performed to generate natural language content describing variations of a workflow in a software application based on recordings of actions performed to complete a base variation of the workflow in the software application. The operations described herein may be executed by one or more systems in a computing environment (e.g., a machine generated content creator 120 illustrated in FIG. 1).

As illustrated, operations 500 may begin at block 510, where a system generates a description of actions performed to complete a first variation of a workflow in a first version of an application. As discussed, the system can generate the description of actions performed to complete the first variation of a workflow as a structured file including a record of each action performed by a user of the application. The description may be generated, for example, based on a recording of a user session in the application.

At block 520, the system executes a plurality of variations of the workflow in a second version of the application based on the generated description of actions. Generally, executing each of the plurality of variations may include injecting commands generated from the description of actions performed to complete the first variation of the workflow regardless of the differences between each variation of the workflow (e.g., language differences, valid and invalid character sets, etc.).

At block 530, the system generates, for each respective variation in the plurality of variations of the workflow, a variation-specific description of actions performed to complete the respective variation of the workflow. Each variation-specific description of actions may include, for example, an indication of the variation and a class of natural language templates to use in generating the natural language description for the respective variation of the workflow. For example, while the generated description of actions may be generated from an English version of an application, each respective variation of the workflow may be associated with templates for a different language for a version of the application made available in different geographic regions.

At block 540, the system generates, for each respective variation in the plurality of variations of the workflow, natural language content using a natural language generation engine. The natural language content generated for each respective variation in the plurality of variations of the workflow may describe the respective variation of the workflow based on the respective variation-specific description of actions performed to complete the respective variation of the workflow.

At block 550, the system outputs the natural language content describing each respective variation of the plurality of variations of the workflow to a user-accessible content repository associated with the application.

### Example Systems for Generating Natural Language Content Describing Workflows in an Application from Recordings of Actions Performed to Execute Workflows in an Application

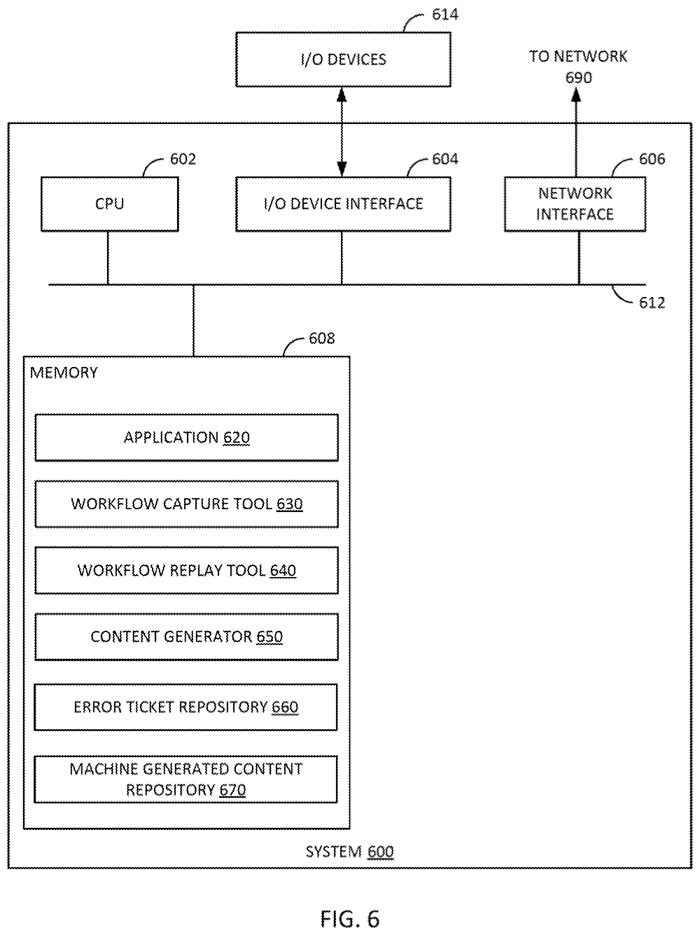

FIG. 6 illustrates an example system 600 that can detect coordinated attacks against resources in a computing system associated with an account provider. For example, system 600 may comprise one or both of application server 110 and/or machine generated content creator 120 illustrated in FIG. 1.

As shown, system 600 includes a central processing unit (CPU) 602, one or more I/O device interfaces 604 that may allow for the connection of various I/O devices 614 (e.g., keyboards, displays, mouse devices, pen input, etc.) to the system 600, network interface 606 through which system 600 is connected to network 690 (which may be a local network, an intranet, the internet, or any other group of computing devices communicatively connected to each other), a memory 608, storage 610, and an interconnect 612.

CPU 602 may retrieve and execute programming instructions stored in the memory 608. Similarly, the CPU 602 may retrieve and store application data residing in the memory 608. The interconnect 612 transmits programming instructions and application data, among the CPU 602, I/O device interface 604, network interface 604, memory 608, and storage 610.

CPU 602 is included to be representative of a single CPU, multiple CPUs, a single CPU having multiple processing cores, and the like.

Memory 608 is representative of a volatile memory, such as a random access memory, or a nonvolatile memory, such as nonvolatile random access memory, phase change random access memory, or the like. As shown, memory 608 includes an application 620, workflow capture tool 630, workflow replay tool 640, content generator 650, error ticket repository 660, and machine generated content repository 670.

Application 620 may correspond to application 112 illustrated in FIG. 1 and may represent an application deployed and maintained in a continuous integration/continuous deployment pipeline. Natural language content describing the actions performed to complete workflows in the application may be generated by workflow capture tool 630, workflow replay tool 640, and content generator 650, and accessible from machine generated content repository 670 through application 620 and/or other applications executing locally on system 600 or on a remote computing system.

Workflow capture tool 630 may correspond to workflow capture tool 122 illustrated in FIG. 1. Generally, workflow capture tool 630 can be used by a user of application 620 to record the actions performed to execute workflows in the application 620. The recording of the actions performed to execute a workflow in the application 620 may be generated, for example, as a parseable file usable by workflow replay tool 640 to generate updated descriptions of actions performed to complete the workflow and identify workflows that have sufficiently changed such that content generator 650 may not be able to generate a natural language description of the workflow.

Workflow replay tool 640 may correspond to workflow replay tool 124 illustrated in FIG. 1. Generally, workflow replay tool 640 can use the recording of the actions performed to execute workflows in application 620 generated by workflow capture tool 630 to execute a workflow in an updated version of application 620 and generate a updated description of actions performed to complete the workflow. In some embodiments, workflow replay tool 640 can generate a video recording while attempting to execute the workflow in the updated version of application 620 based on the recording of the actions performed to execute the workflow in a first version of the application. If workflow replay tool 640 fails to successfully execute the workflow in the updated version of application 620, workflow replay tool 640 can commit a record to error ticket repository 660 to prompt manual review of the workflow in the updated version of application 620. The record committed to error ticket repository 660 may, in some embodiments, include the generated video recording to aid a user in identifying a root cause of the failure to successfully execute the workflow in the updated version of application 620.

Content generator 650 may correspond to content generator 126 illustrated in FIG. 1. Generally, content generator 650 can use of a recording of the actions performed by workflow replay tool 640 to execute a workflow in application 620. Content generator 650 can process the updated description of actions performed to complete the workflow generated by workflow replay tool 640 to remove extraneous actions and records of successive actions performed against a same user interface element. The processed description of actions performed to complete the workflow may be processed into a natural language description of these actions by mapping the records in the processed description of actions to the appropriate natural language templates. The natural language description of the actions performed to complete the workflow may be committed to a machine generated content repository (e.g., machine generated content repository 670) for access through application 620 or remote applications capable of retrieving help content from machine generated content repository 670.

### Additional Considerations

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the embodiments set forth herein. In addition, the scope of the disclosure is intended to cover such an apparatus or method that is practiced using other structure, functionality, or structure and functionality in addition to, or other than, the various embodiments of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for generating natural language content describing a workflow in an application, comprising:
generating a description of actions performed to complete the workflow in a first version of the application;
executing the workflow in a second version of the application based on the generated description of actions;
generating an updated description of actions performed to complete the workflow based on executing the workflow in the second version of the application;
generating, using a natural language generation engine, natural language content describing the workflow based on the updated description of actions performed to complete the workflow; and
outputting the natural language content describing the workflow to a user-accessible content repository associated with the application.

2. The method of claim 1, wherein generating the description of actions performed to complete the workflow comprises:
recording user interaction with user interface elements presented in the workflow; and
generating a structured file including the recorded user interaction, wherein the structured file is ordered based on chronological order of the recorded user interaction with the user interface elements presented in the workflow.

3. The method of claim 2, wherein the structured file includes a plurality of entries, each entry representing an interaction with a single user interface element of the user interface elements presented in the workflow, and each entry including an identification of the single user interface element and an action performed with respect to the single user interface element.

4. The method of claim 1, wherein executing the workflow in the second version of the application comprises:
generating, for each entry in the generated description of actions, a command for a web browser to perform a specified action against a specified user interface element in the workflow; and
executing the command in the web browser.

5. The method of claim 1, further comprising:
generating a video recording of executing the workflow in the second version of the application based on the generated description of actions.

6. The method of claim 5, further comprising:
based on determining that executing the workflow in the second version of the application based on the generated description of actions has failed, generating an entry in an error ticket repository including information identifying the workflow and the generated video recording of executing the workflow.

7. The method of claim 1, wherein generating the natural language content describing the workflow comprises:
generating a filtered version of the updated description of actions performed to complete the workflow to remove irrelevant actions from the updated description of actions; and
generating the natural language content based on the filtered version of the updated description of actions performed to complete the workflow.

8. The method of claim 7, wherein generating the filtered version of the updated description of actions performed to complete the workflow comprises removing, from the updated description of actions, actions performed by a test framework to execute the workflow in the second version of the application.

9. The method of claim 7, wherein generating the filtered version of the updated description of actions performed to complete the workflow comprises consolidating records of successive actions performed against a same target user interface element such that successive entries in the filtered version of the updated description of actions have different target user interface elements.

10. The method of claim 1, wherein generating the natural language content describing the workflow comprises, for each respective entry in the updated description of actions performed to complete the workflow:
identifying a natural language template corresponding to an action identified in the respective entry in the updated description of actions, and
generating a natural language representation of the entry based on the identified natural language template, an identification of a target user interface element included in the respective entry, and an identification of an action performed against the target user interface element included in the respective entry.

11. The method of claim 1, wherein generating the natural language content describing the workflow comprises:
identifying, in the updated description of actions performed to complete the workflow, a transition from a first location in the application to a second location in the application; and
inserting, into the natural language content, a paragraph break between a description of actions performed on the first location in the application and a description of actions performed on the second location in the application.

12. The method of claim 1, wherein:
generating the description of actions performed to complete the workflow in the first version of the application comprises generating the description of actions based on a recording of actions performed to execute a base variation of the workflow in the first version of the application; and
executing the workflow in the second version of the application based on the generated description of actions comprises: executing a plurality of variations of the workflow based on the recording of the actions performed to execute the base variation of the workflow in the first version of the application.

13. The method of claim 12, wherein generating the natural language content describing the workflow based on the updated description of actions performed to complete the workflow comprises: for each of respective variation of the plurality of variations of the workflow, generating a natural language description of actions performed to execute the respective variation of the workflow in a language associated with the respective variation of the workflow.

14. A system, comprising:
a processor; and
a memory having instructions stored thereon which when executed by the processor, performs an operation for generating natural language content describing a workflow in an application, the operation comprising:
generating a description of actions performed to complete the workflow in a first version of the application;
executing the workflow in a second version of the application based on the generated description of actions;
generating an updated description of actions performed to complete the workflow based on executing the workflow in the second version of the application;
generating, using a natural language generation engine, natural language content describing the workflow based on the updated description of actions performed to complete the workflow; and
outputting the natural language content describing the workflow to a user-accessible content repository associated with the application.

15. The system of claim 14, wherein generating the description of actions performed to compete the workflow comprises:
recording user interaction with user interface elements presented in the workflow; and
generating a structured file including the recorded user interaction, wherein the structured file is ordered based on chronological order of the recorded user interaction with the user interface elements presented in the workflow.

16. The system of claim 14, wherein generating the natural language content describing the workflow comprises:
generating a filtered version of the updated description of actions performed to complete the workflow to remove irrelevant actions from the updated description of actions; and
generating the natural language content based on the filtered version of the updated description of actions performed to complete the workflow.

17. The system of claim 16, wherein generating the filtered version of the updated description of actions performed to complete the workflow comprises:
removing, from the updated description of actions, actions performed by a test framework to execute the workflow in the second version of the application; and
consolidating records of successive actions performed against a same target user interface element such that successive entries in the filtered version of the updated description of actions have different target user interface elements.

18. The system of claim 14, wherein generating the natural language content describing the workflow comprises, for each respective entry in the updated description of actions performed to complete the workflow:
identifying a natural language template corresponding to an action identified in the respective entry in the updated description of actions, and
generating a natural language representation of the entry based on the identified natural language template, an identification of a target user interface element included in the respective entry, and an identification of an action performed against the target user interface element included in the respective entry.

19. The system of claim 14, wherein:
generating the description of actions performed to complete the workflow in the first version of the application comprises generating the description of actions based on a recording of actions performed to execute a base variation of the workflow in the first version of the application; and
executing the workflow in the second version of the application based on the generated description of actions comprises: executing a plurality of variations of the workflow based on the recording of the actions performed to execute the base variation of the workflow in the first version of the application.

20. A method for generating natural language content describing a workflow in an application, comprising:
generating a description of actions performed to complete a first variation of a workflow in a first version of an application;
executing a plurality of variations of the workflow in a second version of the application based on the generated description of actions; and
for each respective variation of the plurality of variations of the workflow:
generating a variation-specific description of actions performed to complete the respective variation of the workflow;
generating, using a natural language generation engine, natural language content describing the respective variation of the workflow based on the variation-specific description of actions performed to complete the respective variation of the workflow; and
outputting the natural language content describing the respective variation of the workflow to a user-accessible content repository associated with the application.
